(19) United States
(12) Patent Application Publication
(10) Pub. No.: US 2003/0220778 A1
(43) Pub. Date: Nov. 27, 2003

(54) Method and apparatus for electronically simulating jaw function within electronic model images

(76) Inventors: Bruce Willard Hultgren, Victoria, MN (US); Timothy W. Vadnais, Victoria, MN (US); Michael Craig Marshall, Savage, MN (US); Robert J. Isaacson, Edina, MN (US)

Correspondence Address: MERCHANT & GOULD PC, P.O. BOX 2903, MINNEAPOLIS, MN, 55402-0903, US

(21) Appl. No.: 10/426,253

(22) Filed: Apr. 29, 2003

Related U.S. Application Data
(60) Provisional application No. 60/376,111, filed on Apr. 29, 2002.

(51) Int. Cl. G06G 7/48; G06G 7/58

(52) U.S. Cl. 703/11

(57) ABSTRACT

A method, apparatus, and article of manufacture provide a system for electronically simulating jaw function within electronic model images. With the advances recently made computational systems, these computer based image systems may be used to permit end users to replace paper and physical models with electronic images. A mechanism to capture image representations of physical objects accurately and with sufficient resolution is provided in a form that is both inexpensive to operate while providing rapid turn-around for users. Second, a mechanism to visually display interaction between parts of an object is also provided. These features are expressly addressed for impressions of human teeth that are scanned to allow electronic images of the models of a patient's teeth to be represented and manipulated.

### TECHNICAL FIELD

The invention relates generally to a distributed computing system for the creation and distribution of electronic models of objects and more particularly to a system, method and article of manufacture for electronically simulating jaw function within electronic model images.

### BACKGROUND

Computational resources available for use by various end users of computing systems has increased significantly. This increase in capability of systems has created the ability for many more end users to utilize computer based image systems to replace processes that utilize paper and physical model processes. In the past, computer aided design, drafting, and manufacture (CAD/CAM) tools represented an area of applications in which computer based image systems have migrated from paper and model based processes to electronic systems.

These CAD/CAM system typically consist of design and drafting tools that allow technical designers to build systems that were previously designed on paper using draftsmen. Over time, the computing system and their respective tools have allowed increasing interactive manipulation of components during the design process. This advance in design of items that are then manufactured has occurred using these computer aided systems.

These CAD/CAM systems, however, typically start their processes with a set of pre-defined libraries of components that may be used by the user of the computing system. For example, electronic schematics possess a library of components that are used to specify a circuit and its layout. The creation of these libraries, as well as the amount of computational resources needed to perform the operations related to these systems, has prevented the widespread use of these systems in other areas of technology.

With the advances recently made computational systems, these computer based image systems may be used to permit end users to replace paper and physical models with electronic images. Two areas of technology present additional obstacles to the more wide-spread use of these systems. First, a mechanism to capture image representations of physical objects accurately and with sufficient resolution is needed in a form that is both inexpensive to operate while providing rapid turn-around for users. Second, a mechanism to visually display interaction between parts of an object is needed. This problem is especially acute when impressions of human teeth are to be scanned to allow electronic images of the models of a patient's teeth to be represented and manipulated as individual teeth. Neither of these latter obstacles have been overcome in existing imaging systems.

### SUMMARY

The present invention relates to a method, apparatus, and article of manufacture for electronically simulating jaw function within electronic model images. Other embodiments of a system in accordance with the principles of the invention may include alternative or optional additional aspects. One such aspect of the present invention is a method and computer data product encoding instructions for electronically simulating jaw function within electronic model images.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

FIG. 1 illustrates an electronic image of an eModel having an upper and low set of teeth that has been superimposed upon a other medical image of a patient according to one possible embodiment of the present invention.

FIG. 2a-b illustrate an example of an object from which a eModel is generated according to yet another example embodiment of the present invention.

FIG. 3 illustrates a representation of the object in FIG. 2 using a polygonal mesh according to an embodiment of the present invention.

FIG. 4 illustrates a simplified representation of the object in FIG. 2 using a reduced polygonal mesh according to yet another example embodiment of the present invention.

FIG. 5 illustrates a format for an eModel data file according to yet another example embodiment of the present invention.

FIG. 6 illustrates an electronic image of an eModel having an upper and low set of teeth that has been superimposed upon a other medical image of a patient according to one possible embodiment of the present invention.

FIG. 8a-b illustrates the motion of an upper and low set of teeth along an arc of movement about a point of rotation according to one embodiment of the present invention.

FIG. 9 illustrates a block diagram for a processing system to generate color dental occlusion maps according to another embodiment of the present invention.

FIG. 10 illustrates a function processing flow diagram for a processing system to generate color dental occlusion maps according to yet another embodiment of the present invention.

### DETAILED DESCRIPTION

The present invention relates to a code generation method, apparatus, and article of manufacture for providing a distributed computing system for the creation and distribution of electronic models of objects including a system, method and article of manufacture for electronically generating a color dental occlusion map within electronic model images.

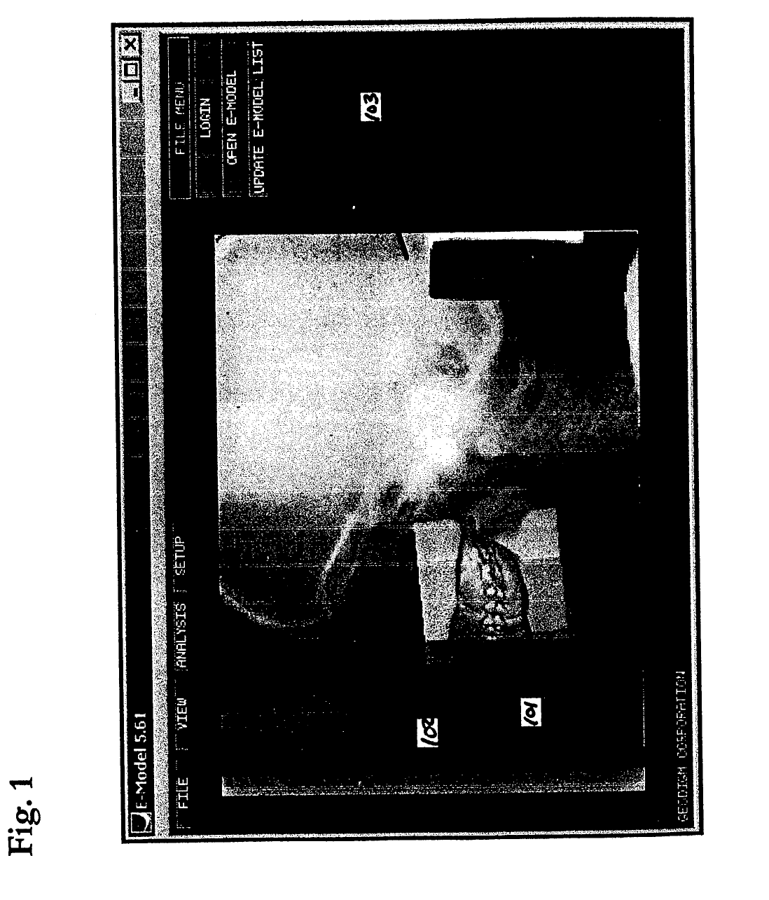

FIG. 1 illustrates an electronic model image of a patient's mouth in which individual teeth have been identified and moved locations in support of a plan of treatment according to one embodiment of the present invention. An electronic model of a patent's upper teeth are shown 102 as they are located within a patients mouth in position relative to a corresponding model of the patient's lower teeth 101. In order for this process to occur, two events must occur. First, an electronic model for the teeth must be generated. This occurs when a physical mold or impression of the mouth is generated. This impression is then electronically scanned to generate the model. The process for generating an electronic model for the teeth is described in commonly assigned U.S. Patent Application entitled “METHOD AND APPARATUS FOR ELECTRONIC DELIVERY OF DENTAL IMAGES”, Ser. No. 09/846,037 filed April 2001, which is incorporated by reference.

Once the electronic model has been generated for the impression, the locations of the individual teeth relative to opposing teeth in the opposite jaw may be determined. Generally, locations where these teeth first make contact as the jaws close is of particular interest. Because these upper and low teeth are known within a common coordinate system, these locations may be easily determined and these points of interest marked for viewing. These points of interest are typically marked with a different color that indicates the distance between the teeth as the jaw is closing.

FIG. 1 also illustrates an electronic image of an eModel having an upper and low set of teeth that has been superimposed upon another medical image of a patient according to one 10 possible embodiment of the present invention. In order to generate an accurate color dental occlusion map to determine how the two sets of teeth interact, the location of the upper teeth 102 must be known relative to the location of the lower teeth 101 as the jaw opens and closes. This location data may be obtained by superimposing the eModel for the teeth upon another image, such as an x-ray 103, in which common locations in both images are identified. Using these common location points, the eModel image and the other medical image may be scaled and oriented onto a common frame of reference. While the example shown herein uses an x-ray image 103, one skilled in the art will recognize that any other medical image having sufficient resolution to permit the accurate registration of the images may be used without deviating from the spirit and scope of the present invention as recited within the attached claims.

Alternatively, the eModel themselves may be used to generate the color occlusion map without the use of another image if the user provides independently obtained measurements for the arc of the jaw as it opens and closes. The x-ray image 103 is useful in determining the point of rotation for the lower jaw to provide a proper definition of the motion of the upper teeth 102 relative to the lower teeth 101 as the jaw moves. This process for generating a color dental occlusion image and manipulating an electronic model for the teeth is described in commonly assigned U.S. Patent Application entitled “METHOD AND APPARATUS FOR ELECTRONICALLY GENERATING A COLOR DENTAL OCCLUSION MAO WITHIN ELECTRONIC MODEL IMAGES”, Ser. No. ______ (Attorney Docket No. 4314.71-US-P1) filed______, which is incorporated by reference.

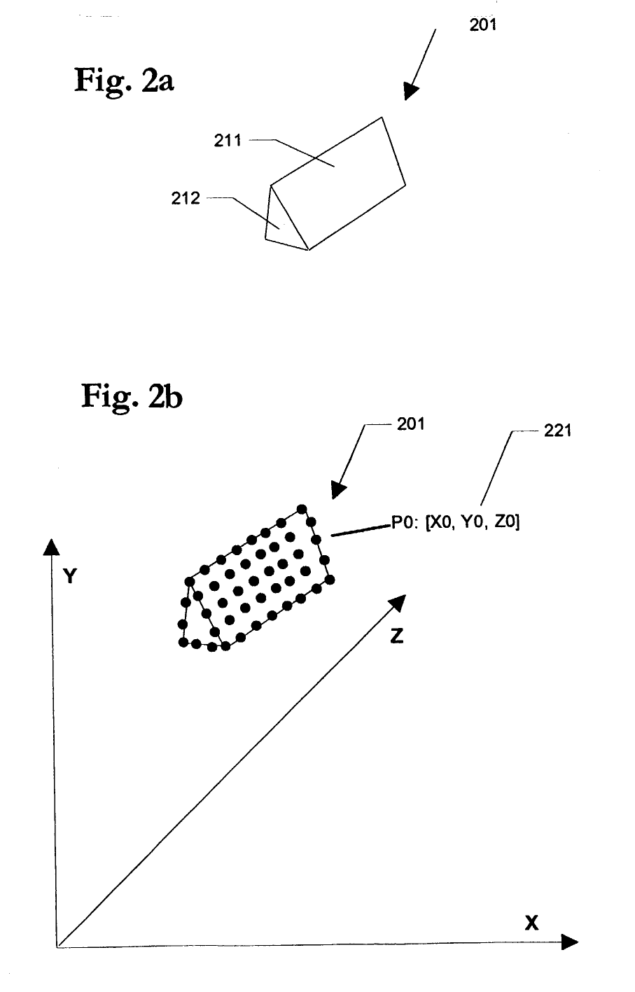

FIG. 2a-b illustrate an example of an object from which a eModel is generated according to yet another example embodiment of the present invention. A simple geometric 3D shape 201 is presented as an example of how a reduced polygonal mesh is generated that may be used as an eModel. This shape 201 has two visible faces: a small triangular side face 212 and a larger rectangular face 211. Three other faces make up this simple object that are not visible from the perspective shown in FIG. 2a.

FIG. 2b shows this object 201 having a set of surface data points superimposed upon the object 201 faces. When a laser line scanner passes its sensor over a face of the object 201, a line of points corresponding to the position of the objects' surface are obtained. These points are separated by the spatial resolution of the scanner. The data points, P0 221 are specified using a 3 coordinate position X0, Y0, Z0. As the object 201 is moved within the scanning area of the multi-axis platform, the scanner translates the data points to a common coordinate system such that the collection of all points represents the points in a 3D coordinate system that corresponds to the surface of the item 201. These data points are contained within the point cloud data file 500.

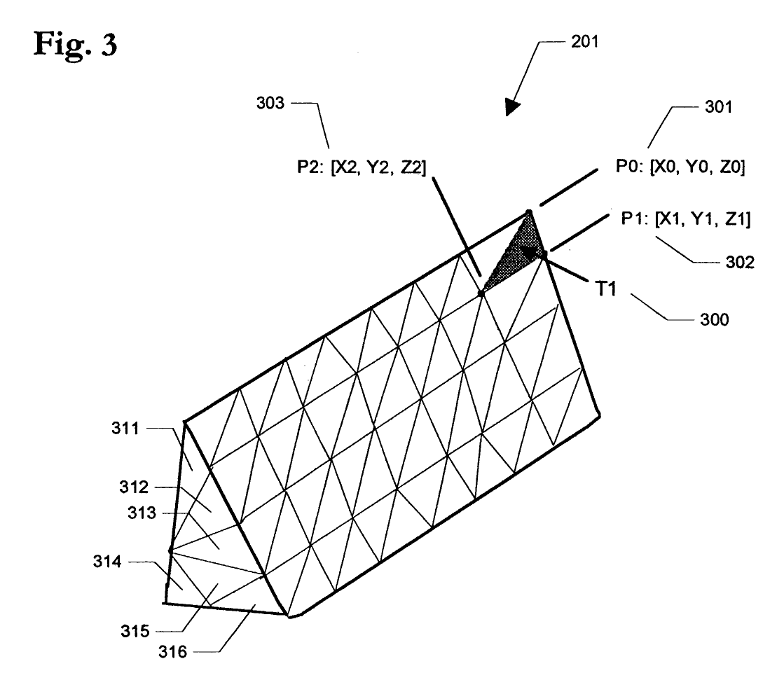

FIG. 3 illustrates a representation of the object in FIG. 2 using a polygonal mesh according to an embodiment of the present invention. As discussed above, the point cloud data file 500 is reduced to a polygonal mesh of triangles in which the surface of the triangles are used to approximate the surface of the item 201. In this example, a triangle, T1 300, is located on the larger surface 211 of the item 201. The triangle T1 300 is specified using the three corner points P0 301, P1 302, and P3 303. As before, each of these three points are specified using a 3D coordinate system such that T1 300 is defined:

T1: {P0,P1,P2 }

or

T1: {[X0, Y0, Z0], [X1, Y1, Z1], {[X2, Y2, Z2]}.

Each triangle in the polygonal mesh is specified using the three points as shown above. No particular order for the points making up the triangle is necessary. The smaller side 212 of the item 211 in this example is initially shown with six triangles 311-316. The triangles in the polygonal mesh may be created using any number of well known methods for reducing point position data into a polygonal mesh that approximates the surface of the object.

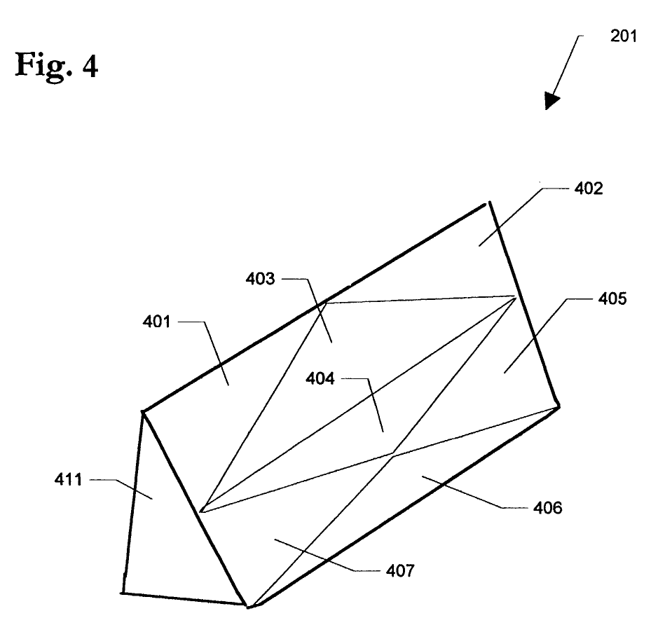

FIG. 4 illustrates a simplified representation of the object in FIG. 2 using a reduced polygonal mesh according to yet another example embodiment of the present invention. A reduced polygonal mesh is generated by combining adjacent triangles in the original polygonal mesh when the two or more triangles are sufficiently coplanar that they may be represented using a single triangle. In this example, a large number of small triangles may have been originally generated mesh shown in FIG. 3. When a flat surface of the simple object 201 is considered, the number of triangles needed is reduced significantly 401-407. In the example, all of the small triangles from the small side 212 of the item 201 have been combined into a single triangle 411. The processing associated with this filtering operation controls the amount of triangle combination by setting a threshold relating to the minimum amount of deviation from a single plane for the two or more triangles that is permitted before two or more triangles are required to remain separate. This filtering process may be accomplished using a number of commercially available polygonal mesh processing products without deviating from the present invention as recited within the attached claims.

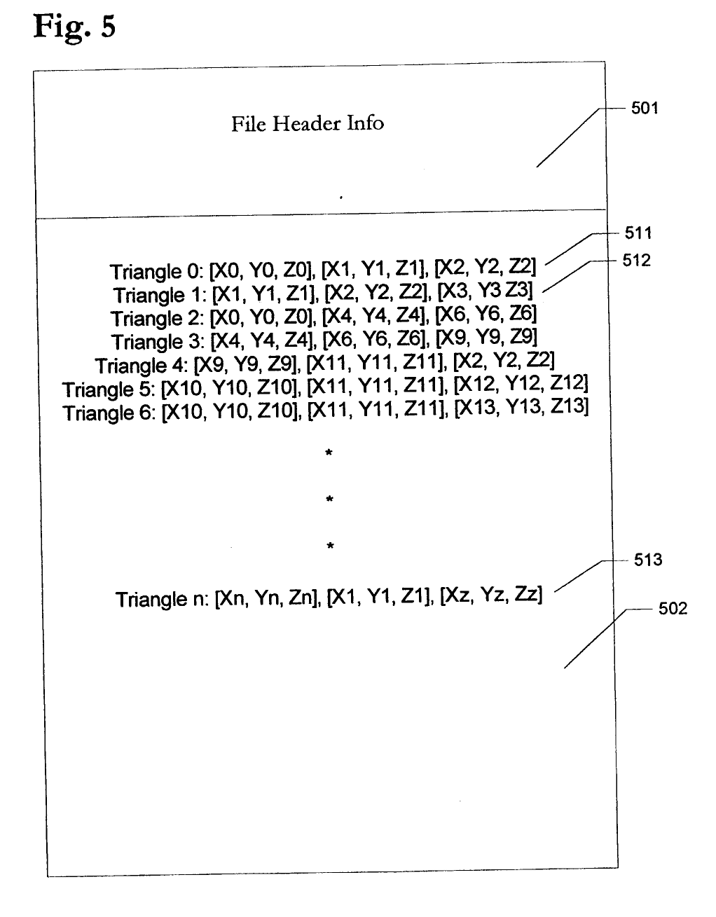

FIG. 5 illustrates a format for an eModel data file according to yet another example embodiment of the present invention. The eModel data file 500 consists of a file header info block 501 and a triangle specification block 502. The triangle specification block consists of the set of triangle definitions 511-513 that are used to define the reduced polygonal mesh. The file header info block 501 includes a set of searchable identification information that may be used to identify a particular model from any number of related models. The mouth and teeth eModels, for example, will likely contain patient identification information such as name, date of birth, address, social security number that may be used to uniquely identify the patient from which the model was generated. The info block 511 may also contain dental care provider information such as the dentist name and address as well as the date on which the impression was taken that generated the eModel.

This data file 500 is typically ASCII encoded data that may be easily searched and processed as necessary. One skilled in the art will recognize how this file header info block 501 may be modified to include any information needed by a particular application without deviating from the spirit and scope of the present invention as recited within the attached claims.

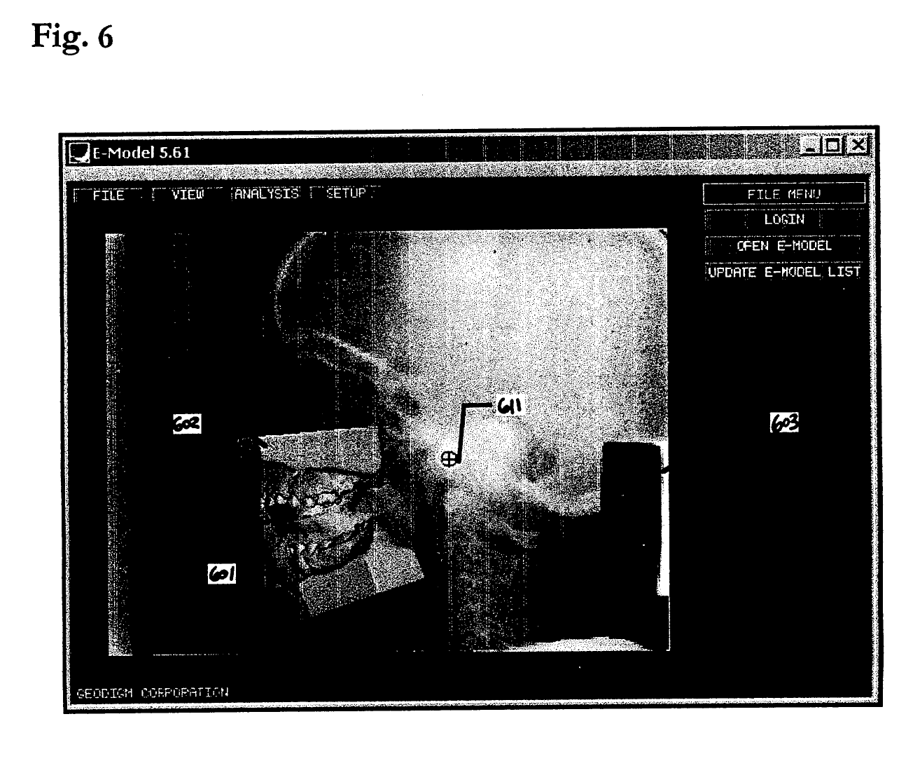

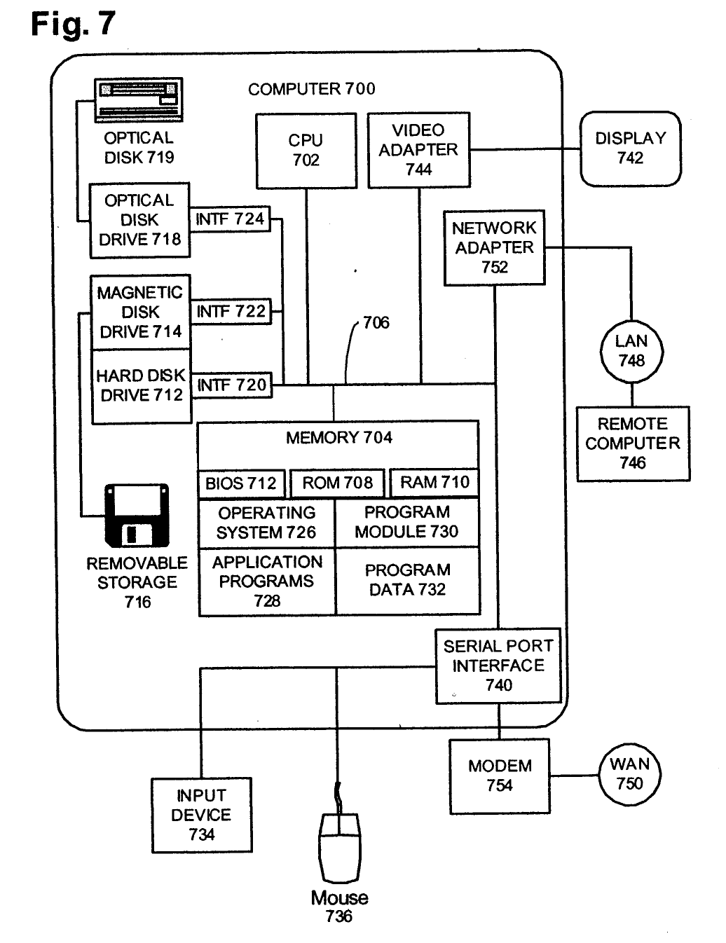

FIG. 6 illustrates an electronic image of an eModel having an upper and low set of teeth that has been superimposed upon a other medical image of a patient according to one possible embodiment of the present invention. In this image, the upper teeth 602 and the lower teeth 601 are again superimposed upon another image 603 of the patient. After the two set of images are properly scaled and registered, the point of rotation for the jaw 603 may be identified. From this point 603, and its distance from the individual teeth, the arc of motion for the lower jaw 601 may be defined. Once the movement of the teeth relative to the opposing set of teeth is defined, the color dental occlusion map may be created.

FIG. 7 illustrates an exemplary system for implementing the invention includes a general-purpose computing device in the form of a conventional personal computer 700, including a processor unit 702, a system memory 704, and a system bus 706 that couples various system components including the system memory 704 to the processor unit 700. The system bus 706 may be any of several types of bus structures including a memory bus or memory controller, a peripheral bus and a local bus using any of a variety of bus architectures. The system memory includes read only memory (ROM) 808 and random access memory (RAM) 710. A basic input/output system 712 (BIOS), which contains basic routines that help transfer information between elements within the personal computer 700, is stored in ROM 708.

The personal computer 700 further includes a hard disk drive 712 for reading from and writing to a hard disk, a magnetic disk drive 714 for reading from or writing to a removable magnetic disk 716, and an optical disk drive 718 for reading from or writing to a removable optical disk 719 such as a CD ROM, DVD, or other optical media. The hard disk drive 712, magnetic disk drive 714, and optical disk drive 718 are connected to the system bus 706 by a hard disk drive interface 720, a magnetic disk drive interface 722, and an optical drive interface 724, respectively. The drives and their associated computer-readable media provide nonvolatile storage of computer readable instructions, data structures, programs, and other data for the personal computer 700.

Although the exemplary environment described herein employs a hard disk, a removable magnetic disk 716, and a removable optical disk 719, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 716, optical disk 719, ROM 708 or RAM 710, including an operating system 726, one or more application programs 728, other program modules 730, and program data 732. A user may enter commands and information into the personal computer 700 through input devices such as a keyboard 734 and mouse 736 or other pointing device. Examples of other input devices may include a microphone, joystick, game pad, satellite dish, and scanner. These and other input devices are often connected to the processing unit 702 through a serial port interface 740 that is coupled to the system bus 706. Nevertheless, these input devices also may be connected by other interfaces, such as a parallel port, game port, or a universal serial bus (USB). A monitor 742 or other type of display device is also connected to the system bus 706 via an interface, such as a video adapter 744. In addition to the monitor 742, personal computers typically include other peripheral output devices (not shown), such as speakers and printers.

The personal computer 700 may operate in a networked environment using logical connections to one or more remote computers, such as a remote computer 746. The remote computer 746 may be another personal computer, a server, a router, a network PC, a peer device or other common network node, and typically includes many or all of the elements described above relative to the personal computer 700. The network connections include a local area network (LAN) 748 and a wide area network (WAN) 750. Such networking environments are commonplace in offices, enterprise-wide computer networks, intranets, and the Internet.

When used in a LAN networking environment, the personal computer 700 is connected to the local network 748 through a network interface or adapter 752. When used in a WAN networking environment, the personal computer 700 typically includes a modem 754 or other means for establishing communications over the wide area network 750, such as the Internet. The modem 754, which may be internal or external, is connected to the system bus 706 via the serial port interface 740. In a networked environment, program modules depicted relative to the personal computer 700, or portions thereof, may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

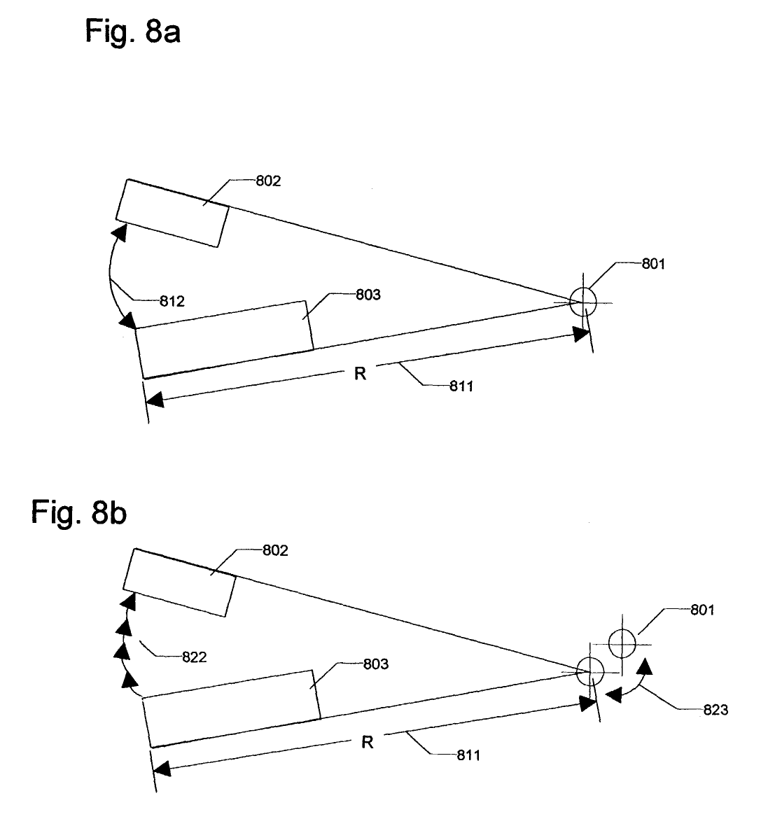

FIG. 8a-b illustrates the motion of an upper and low set of teeth along an arc of movement about a point of rotation according to one embodiment of the present invention. The arc of motion 812 for a set of lower teeth 803 relative to a set of upper teeth 802 is defined as an arc of a circle having a radius R. The radius R 811 is defined by the geometry of a patient's mouth and may be measured mechanically or obtained from an electronic image. FIG. 8a shows an idealized arc of motion 812 where it is assumed that the point of rotation 801 for a jaw is a fixed point in space.

FIG. 8b shows an arc of motion 822 for the teeth as a series of individual arcs of motion where the individual arcs are determined from a set of positions for the point of rotation 801. In many patients, the point of rotation moves a small distance along a path of pivot 823 as the jaw moves from a fully open to a fully closed position. This path 823 is created because of the interaction of the jaw in its socket which is not a fixed joint. As such, the arc or movement for the teeth corresponds to a arc of a circle having a radius R 811 where the center of the circle follows the path of pivot 823 as the teeth are moved.

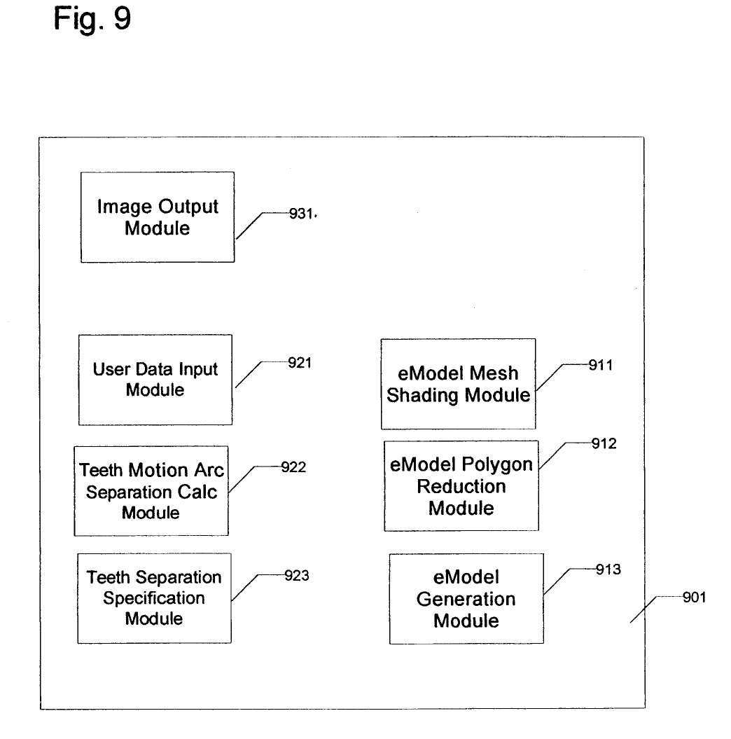

FIG. 9 illustrates a block diagram for a processing system to generate color dental occlusion maps according to another embodiment of the present invention. The processing system includes a set of processing modules to perform the tasks associated with generating a color dental occlusion map. The set of processing modules includes an eModel Mesh Shading module 911, an eModel polygon reduction module 912, an eModel generation module 913, a teeth separation color mapping module 921, a teeth vertex separation calculation module 922, a teeth separation specification module 923, and an image output module 931.

The eModel Mesh Shading module 911, the eModel polygon reduction module 912, and the eModel generation module 913 perform the operations needed to generate and shade the eModel. These modules implement the process for generating an electronic model for the teeth is described in commonly assigned U.S. Patent Application entitled “METHOD AND APPARATUS FOR ELECTRONIC DELIVERY OF DENTAL IMAGES”, Ser. No. 09/846,037 filed April 2001, which is incorporated by reference.

The user data input module 921 provides a mechanism for the user to indicate how the separation for the two parts of the eModel of a patient's teeth are to be manipulated. In a preferred embodiment, a user manipulates one of the two sets of teeth with an input device such as a mouse to move it along its arc of motion to reach a desired location. To accurately model the function of human teeth, the upper set of teeth are typically held in a fixed position with the lower teeth moving relative to the upper teeth. However, the system allows for either set of teeth to be moved relative to the other set as dental practitioners may wish to see the movement of upper teeth as would typically occur with the use of physical models of teeth. The motion arc separation calculation module 922 calculates the motion of the teeth and the motion of the point of rotation as described above in FIG. 8. The teeth separation specification module 923 accepts input from the user to manipulate the two parts of an eModel. The image output module 931 generates the image seen by a user on a display device that includes an eModel after it has been updated as needed.

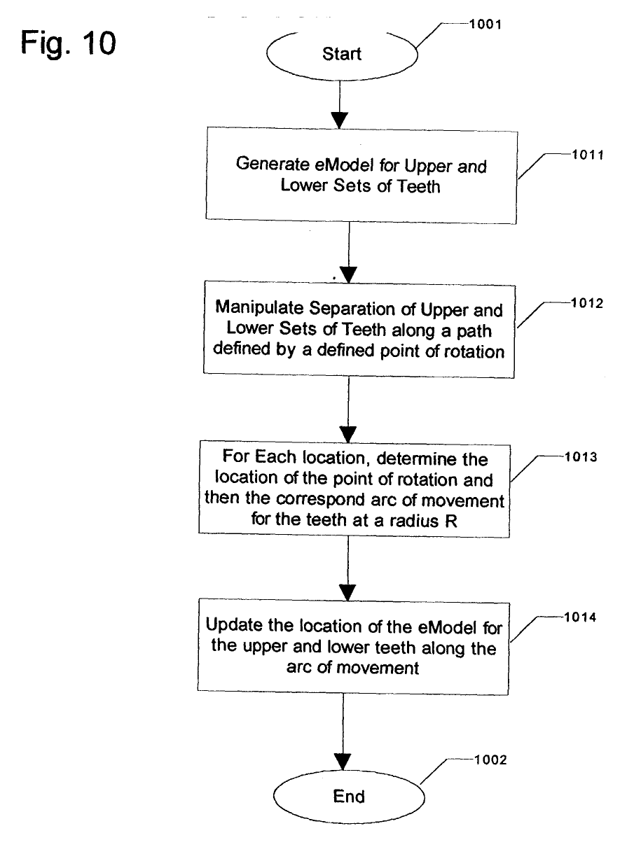

FIG. 10 illustrates a function processing flow diagram for a processing system to generate color dental occlusion maps according to yet another embodiment of the present invention. The processing starts 1001 and an eModel is generated for both the upper teeth and the lower teeth in module 1011. The process for generating an electronic model for the teeth is described in commonly assigned U.S. Patent Application entitled “METHOD AND APPARATUS FOR ELECTRONIC DELIVERY OF DENTAL IMAGES”, Ser. No. 09/846,037 filed April 2001, which is incorporated by reference.

Once the eModels are generated, module 1012 allows a user to move the upper and lower teeth to a desired separation distance for the upper and lower teeth in the eModel using an input device such as a mouse. The teeth move along an arc of motion defined by a point of rotation for the jaw and the distance of the teeth from this point of rotation as discussed above with respect to FIG. 8. The movement of the point of rotation and its corresponding effect on the movement of the two teeth sets in the eModel is generated in module 1013. Module 1014 then calculates the updated position for the teeth.

The process of manipulating the separation of the two parts of the eModel, calculating the movement of the teeth, and performing any additional processing or analysis may be interactively repeated as necessary based upon input from a user. Once the eModel has been moved to a new position, the eModel may also be manipulated, rotated, zoomed, etc as the user performs analysis of the interaction of the patient's teeth.

FIG. 7 illustrates an example of a suitable operating environment in which the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A computing system 901 typically includes at least some form of computer readable media. Computer readable media can be any available media that can be accessed by the network server 110. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 901.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or directwired connection, and wireless media such as acoustic, RF, infrared and other wireless media. Combinations of any of the above should also be included within the scope of computer readable media.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for electronically simulating jaw function within electronic model images.

What is claimed is:

1. A method for electronically simulating jaw function within electronic model images, the method comprising:
generating a electronic model of an upper set of teeth and a lower set of teeth;
manipulating a spatial separation of the upper set of teeth relative to the lower set of teeth along a path defined by a point of rotation and a known radius of rotation;
for each location in the path, calculating a position for the point of rotation along arc of movement; and
updating the location of the upper set of teeth and the lower set of teeth to corrspond to a position associated with the calculated position for the point of rotation.

2. A system for electronically simulating jaw function within electronic model images, the method comprising:
means for generating a electronic model of an upper set of teeth and a lower set of teeth;
means for manipulating a spatial separation of the upper set of teeth relative to the lower set of teeth along a path defined by a point of rotation and a known radius of rotation;
means for calculating a distance to an opposing mesh surface for each triangle vertex in a polygonal mesh; and
means for painting a surface of the polygonal mesh within each triangle a color corresponding to the calculated distance between the triangle vertex and the opposing mesh surface for each triangle in the polygonal mesh.

3. A computer program data product readable by a computing system and encoding instructions implementing a method for electronically simulating jaw function within electronic model images, the method comprising:
generating a electronic model of an upper set of teeth and a lower set of teeth;
manipulating a spatial separation of the upper set of teeth relative to the lower set of teeth along a path defined by a point of rotation and a known radius of rotation;
for each location in the path, calculating a position for the point of rotation along arc of movement; and
updating the location of the upper set of teeth and the lower set of teeth to corrspond to a position associated with the calculated position for the point of rotation.
